(19) United States
(12) Patent Application Publication
(10) Pub. No.: US 2026/0237194 A1
(43) Pub. Date: Aug. 13, 2026

(54) REAL-TIME DEFECT DETECTION METHOD FOR METAL DEPOSITION BASED ON ARTIFICIAL INTELLIGENCE

(71) Applicants: Shaoxing University, Shaoxing (CN); ZHEJIANG PROVINCE INSTITUTE OF ARCHITECTURAL DESIGN AND RESEARCH, Hangzhou (CN)

(72) Inventors: Zhen WANG, Shaoxing (CN); Jun YE, Shaoxing (CN); Yang ZHAO, Shaoxing (CN); Gaoyang LIU, Shaoxing (CN); Xuelin YANG, Shaoxing (CN); Haochuan QU, Shaoxing (CN); Duanrui YANG, Shaoxing (CN); Zhongliang XIE, Shaoxing (CN)

(21) Appl. No.: 19/531,602

(22) Filed: Feb. 5, 2026

(30) Foreign Application Priority Data
Feb. 11, 2025 (CN) 202510149919.5

(51) Int. Cl. G06V 10/774; G06V 10/52; G06V 10/764; G06V 10/77; G06V 10/776; G06V 10/82; G06V 10/98; G06V 20/70

(52) U.S. Cl. CPC G06V 10/774; G06V 10/52; G06V 10/764; G06V 10/7715; G06V 10/776; G06V 10/82; G06V 10/993; G06V 20/70; G06V 2201/06

(57) ABSTRACT

The present application relates to a real-time defect detection method for metal deposition based on artificial intelligence, which includes: acquiring a deposition defect dataset and extracting key deposition features by using a backbone network; capturing high-level semantic features in the deposition features and performing multi-scale feature fusion by a high-efficiency hybrid encoder; adopting an Intersection over Union (IoU) aware query selection method to assign corresponding classification scores to deposition features with different IoU values during the training process for constraining model learning, and selecting more accurate deposition features in the decoding stage by optimizing object queries; mapping the optimized objects to classification confidence and bounding boxes, and accelerating training convergence through a denoising module in a decoder.

### CROSS-REFERENCE TO RELATED APPLICATIONS

The present application claims priority to Chinese patent application No. 202510149919.5, filed on Feb. 11, 2025, the entire contents of which are incorporated herein by reference.

### TECHNICAL FIELD

The present application relates to the technical field of additive manufacturing, and more particularly, to a real-time defect detection method for metal deposition based on artificial intelligence.

### BACKGROUND

Metal additive manufacturing and metal weld welding are effective methods for integrated deposition manufacturing and welded connection of metal structures in industries such as construction machinery, aerospace, and automobile manufacturing. The metal additive manufacturing is used to directly manufacture integral metal structures in a single monolithic piece by heating wire materials at high temperatures, and the metal weld welding connects metal structures by welding with high-temperature heating. Deposition defects generated during the deposition process not only affect the appearance of structures but also jeopardize their performance and safety. Therefore, real-time detection and evaluation of deposition defects are crucial to ensuring the safety and reliability of industrial facilities.

Traditional deposition defect detection generally collects data through methods such as X-ray, laser scanning and ultrasonic testing, and processes the data by means of computer-aided algorithms. However, the accuracy of these detection methods is heavily dependent on experience, resulting in low efficiency, high subjectivity and unreliable detection results, and failing to achieve real-time detection effects. Thus, there is an urgent need to develop an efficient and accurate end-to-end target detection method for real-time detection of deposition defects, so as to adapt to the practical application in various complex scenarios.

With the development of deep convolutional neural networks (CNNs), target detection algorithms have acquired strong capabilities in feature extraction and complex pattern learning. CNNs have significantly improved the accuracy of image recognition and have high applicability in deposition defect detection. At present, a variety of model algorithms and detection methods have been developed based on this technology. However, the structures of existing detection model algorithms are often overly complex and require multi-stage training, leading to low computational efficiency, which thus poses great challenges to their application in realizing real-time detection.

Especially in complex metal deposition application scenarios with high temperature and high speed such as wire arc additive manufacturing (WAAM), the real-time and accurate detection of deposition defects is essential to structural safety and production efficiency. Without real-time detection and adjustment, deposition defects may be overlooked due to the overlapping of deposition layers, thereby leading to hidden defects. However, most of the existing real-time detectors rely on CNN-based architectures and require non-maximum suppression (NMS) for post-processing, which slows down the detection speed and introduces hyperparameters that cause instability in computational efficiency and effectiveness.

In summary, it is highly necessary to study a real-time defect detection method for metal deposition based on artificial intelligence to achieve efficient, real-time and accurate detection in multi-layer and multi-pass complex deposition defect application scenarios with high temperature and high speed such as wire arc additive manufacturing.

### SUMMARY

The purpose of the present application is to address the shortcomings of the related art and propose a real-time defect detection method for metal deposition based on artificial intelligence.

In a first aspect, there is provided a real-time defect detection method for metal deposition based on artificial intelligence, which includes:
S1. acquiring a deposition defect dataset, and extracting key deposition features by using a backbone network;
S2. constructing a high-efficiency hybrid encoder by combining an attention mechanism and multi-layer convolution operation, capturing high-level semantic features in the key deposition features and performing multi-scale feature fusion through the high-efficiency hybrid encoder;
S3. adopting an Intersection over Union (IoU) aware query selection method to assign corresponding classification scores to key deposition features with different IoU values during a training process to constrain model learning, and selecting more accurate key deposition features in a decoding stage by optimizing object queries; and
S4. mapping optimized objects to classification confidence and bounding boxes by using a decoder with an auxiliary prediction head, and accelerating training convergence through a denoising module in the decoder.

In one embodiment, step S1 further includes: expanding the deposition defect dataset by using a data augmentation method.

In one embodiment, in step S1: for the deposition defect dataset, labeling samples as “good” or “bad” according to a presence or absence of defects and conduct annotation; wherein deposition defects include deposition burrs, deposition holes and deposition dents; dividing the deposition defect dataset into a training set and a validation set, which are configured for model training and performance evaluation respectively.

In one embodiment, in step S1, the backbone network is a modified PResNet50, in which an initial 7×7 convolution layer is replaced with three 3×3 convolution layers, and a 2×2 average pooling layer is introduced into residual blocks to replace part of 1×1 convolution layers; and the modified PResNet50 is configured to enhance a retention of key deposition information and improve an efficiency of deposition feature extraction.

In one embodiment, in step S2: the high-efficiency hybrid encoder comprises an intra-scale feature interaction module based on an attention mechanism and a cross-scale feature fusion module based on a convolutional neural network; the intra-scale feature interaction module is configured to capture high-level semantic features in the key deposition features; the cross-scale feature fusion module is configured to fuse multi-scale features and enhance overall deposition feature information.

In one embodiment, in step S2: for shallow deposition features, convolution layers are adopted for extraction; for deep deposition features containing corresponding high-level deposition semantic features, deposition feature maps output by the high-efficiency hybrid encoder are used for cross-scale fusion to perform multi-scale deposition feature extraction and improve the efficiency of deposition feature extraction.

In one embodiment, in step S2: a parallel structure is adopted to extract deposition features of different degrees from the deposition feature maps, and deposition feature maps of various scales are combined to enhance the fusion effect of the key deposition features.

In one embodiment, in step S3: a Precision, a Recall and a mean Average Precision (mAP) are adopted as evaluation indicators, and an IoU between predicted labeled boxes and actual labeled boxes is adopted as an evaluation threshold;

calculation formulas of the Precision, the Recall, an Average Precision (AP) and the mAP are as follows:

$$P = \frac{TP}{TP + FP} \qquad ( 1 )$$

$$R = \frac{TP}{TP + FN} \qquad ( 2 )$$

$$AP = {\sum }_{k = 1}^{N} {max}_{\tilde{k} \geq k} p ( \tilde{k} ) Δ R ( k ) \qquad ( 3 )$$

$$mAP = \frac{{\sum }_{i = 1}^{N} {AP}_{i}}{n} \qquad ( 4 )$$

wherein, P represents the Precision, R represents the Recall, AP represents the Average Precision, mAP represents the mean Average Precision; a True Positive (TP), a False Positive (FP) and a False Negative (FN) respectively represent “true positive value”, “false positive value” and “false negative value”, which are defined according to an IoU between predicted bounding boxes and a ground truth; \tilde{k} is the Recall at any point on a Precision-Recall curve p(\tilde{k}); k is a serial number of interpolation points; N is a total number of interpolation points p(\tilde{k}); is a Precision function at the Recall of \tilde{k}. ΔR(k) is a Recall variation between a (k−1)-th and k-th interpolation points; n is a total number of categories in multi-category object detection; i is a category serial number; the bounding box is labeled as the TP when the IoU is greater than the threshold for representing a number of correctly identified objects; the bounding box is labeled as the FP when the IoU is less than or equal to the threshold for representing a number of incorrectly identified objects.

In one embodiment, in step S3: Frames Per Second (FPS) is adopted as a main indicator for evaluating detection speed when measuring the detection speed.

In one embodiment, in step S4: during the training process, the ground truth boxes are denoised and used as a part of an input of the decoder to accelerate a training convergence speed; a piecewise decay schedule and linear warm-up are adopted to set a learning rate for solving a problem of training hyperparameters.

In a second aspect, there is provided a real-time defect detection system for metal deposition based on artificial intelligence, for executing any one of the methods according to the first aspect, and including:
an acquisition module, configured to acquire a deposition defect dataset, and extracting key deposition features by using a backbone network;
a construction module, configured to construct a high-efficiency hybrid encoder by combining an attention mechanism and multi-layer convolution operation, capturing high-level semantic features in the key deposition features and performing multi-scale feature fusion through the high-efficiency hybrid encoder;
an assignment module, configured to adopt an Intersection over Union (IoU) aware query selection method to assign corresponding classification scores to key deposition features with different IoU values during a training process to constrain model learning, and select more accurate key deposition features in a decoding stage by optimizing object queries; and
a mapping module, configured to map optimized objects to classification confidence and bounding boxes by using a decoder with an auxiliary prediction head, and accelerate training convergence through a denoising module in the decoder.

In a third aspect, a computer storage medium is provided, wherein a computer program is stored in the computer storage medium; when the computer program runs on a computer, the computer is caused to execute any one of the methods according to the first aspect.

In a fourth aspect, there is provided an electronic device, which includes:
a memory, configured to store a computer program;
a processor, configured to execute the computer program to implement any one of the methods according to the first aspect.

The beneficial effects of the present application are as follows:
1. The real-time defect detection method for metal deposition based on artificial intelligence provided by the present application takes deposition defects as the object and designs an artificial intelligence algorithm model of end-to-end Real-Time Detection Transformer (RT-DETR). It has fast training speed and strong generalization ability, and is suitable for deposition application scenarios requiring efficient, real-time and accurate detection such as wire arc additive manufacturing (WAAM).
2. Compared with traditional detection methods, the real-time metal deposition detection method based on artificial intelligence provided by the present application has higher detection accuracy and can identify and classify targets more precisely. By combining the conversion architecture with real-time processing optimization, it effectively solves the problems of low detection accuracy and slow detection timeliness of deposition defects in the wire arc additive manufacturing process and weld welding process.
3. The real-time metal deposition detection method based on artificial intelligence provided by the present application extracts key deposition features through the backbone network to improve the detection accuracy of deposition defects, improves deposition feature capture and fusion through the high-efficiency hybrid encoder to enhance the accuracy and efficiency of the detection model, improves the accuracy of the prediction framework through Intersection over Union (IoU) aware query selection, and improves the classification and bounding box prediction accuracy through the decoder with an auxiliary prediction head, thereby realizing real-time detection of metal material deposition defects.

### BRIEF DESCRIPTIONS OF THE DRAWINGS

FIG. 1 is a schematic diagram of an overall process of the real-time defect detection method for metal deposition based on artificial intelligence of the present application.

FIG. 2 is a schematic diagram of the overall real-time detection framework.

FIG. 3a is a typical schematic diagram of the good target deposition defect image with good quality.

FIG. 3b is a schematic diagram of burrs in the poor target deposition defect image.

FIG. 3c is a schematic diagram of holes in the poor target deposition defect image.

FIG. 4a is a splicing schematic diagram of deposition defect images after Mosaic data augmentation.

FIG. 4b is another splicing schematic diagram of deposition defect images after Mosaic data augmentation.

FIG. 5 is a schematic diagram of the architecture of the PResNet50 backbone network.

FIG. 6 is a schematic diagram of the architecture of the Intra-scale Feature Interaction (AIFI).

FIG. 7 is a schematic diagram of the architecture of the Cross-scale Feature Fusion Module (CCFM).

FIG. 8 is a schematic diagram of the architecture of IoU-aware query selection and the decoder in an end-to-end Real-Time Detection Transformer (RT-DETR).

FIG. 9a is a curve showing an evolution process of mAP@0.5 during a real-time detection training process.

FIG. 9b is a curve showing the evolution process of mAP@0.5:0.95 during a real-time detection training process.

FIG. 10a is an original deposition image of a wire arc additive manufacturing process.

FIG. 10b is a labeled deposition image of the wire arc additive manufacturing process.

FIG. 10c is a real-time detection result image of deposition defects in the wire arc additive manufacturing process.

### DETAILED DESCRIPTIONS OF EMBODIMENTS

The present application is further described below in conjunction with the examples. The description of the following examples is only for helping to understand the present application. It should be pointed out that for those skilled in the technical field, several modifications can be made to the present application without departing from the principles of the present application, and these improvements and modifications also fall within the protection scope of the claims of the present application.

### Example 1

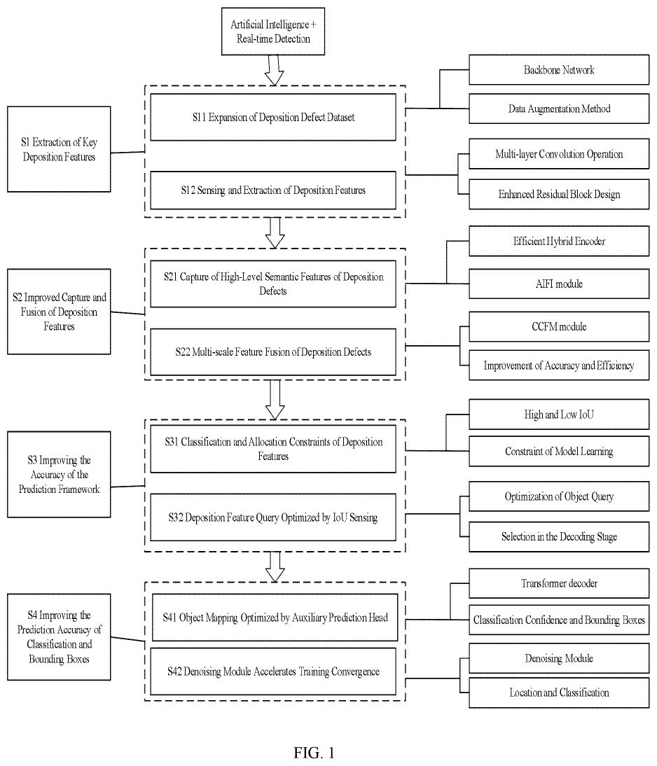

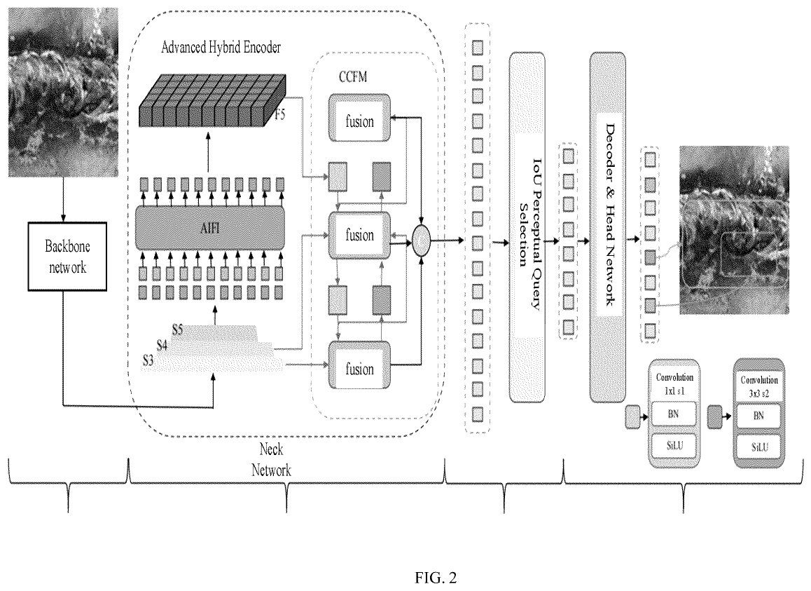

To solve the problems of the related art, Example 1 of the present application provides a real-time defect detection method for metal deposition based on artificial intelligence, which, as shown in FIG. 1 and FIG. 2, includes:

S1. acquiring a deposition defect dataset, and extracting key deposition features by using a backbone network.

In S1, the deposition defects include deposition burrs, deposition holes and deposition dents, etc., which are mainly caused by improper deposition current and deposition speed. The deposition defects will seriously affect the integrity and safety of wire arc additive manufacturing structural parts or weld welding structural parts.

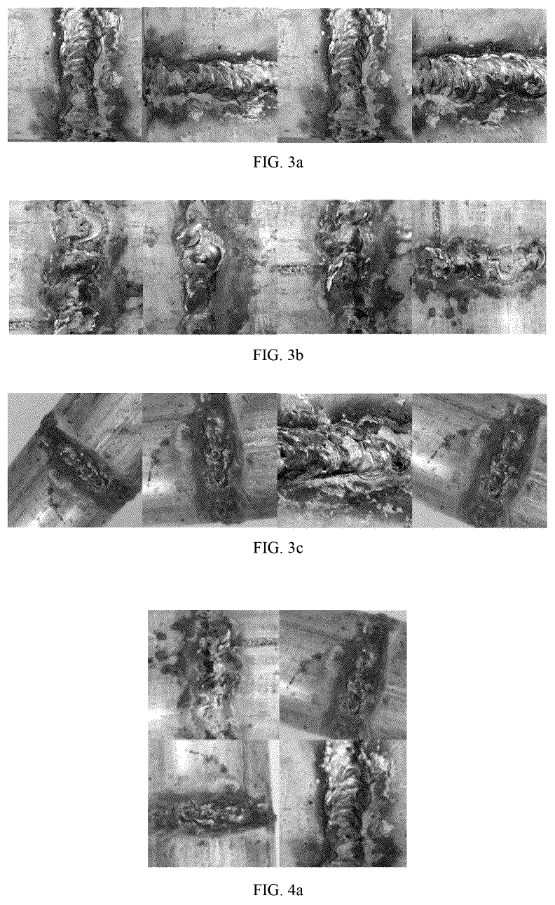

As shown in FIG. 3, the deposition defect dataset is labeled as good (FIG. 3a) or poor (FIG. 3b-FIG. 3c) and annotated according to the presence or absence of defects such as burrs (FIG. 3b) and holes (FIG. 3c). The deposition defect dataset shall cover common deposition defects, and each type of deposition defect is carefully annotated to ensure accuracy and diversity. These target deposition defect images provide detailed information on potential quality problems during the wire arc additive manufacturing or weld welding process, making the deposition defect dataset highly representative and practical. For model training and performance evaluation, the deposition defect dataset is divided into a training set and a validation set at a ratio of 8:2, which can ensure the sufficiency of training data and the reliability of validation results.

In S1, the multi-layer convolution operation module of the PResNet50 backbone network is used to improve the perception ability and extraction efficiency of the model algorithm for deposition features. The enhanced residual block design module of the PResNet50 backbone network is used to improve the retention of deposition information and the detection accuracy of deposition defects. As shown in FIG. 5, the PResNet50 backbone network is also improved, the 7×7 convolution layer is replaced with three 3×3 convolution layers for operation, which enhances the extraction of deposition features while maintaining the same output. In the first residual block of the 2nd, 3rd and 4th stages, the 1×1 convolution layer (a kernel size of 1×1, a stride of 2) is replaced with a 2×2 average pooling layer (a kernel size of 2×2, a stride of 2) and a 1×1 convolution layer for operation, so as to better retain key deposition information and improve the efficiency of deposition feature extraction. Through the above operations, the computational cost is significantly reduced by using smaller feature maps, and the timeliness of deposition defect detection is improved.

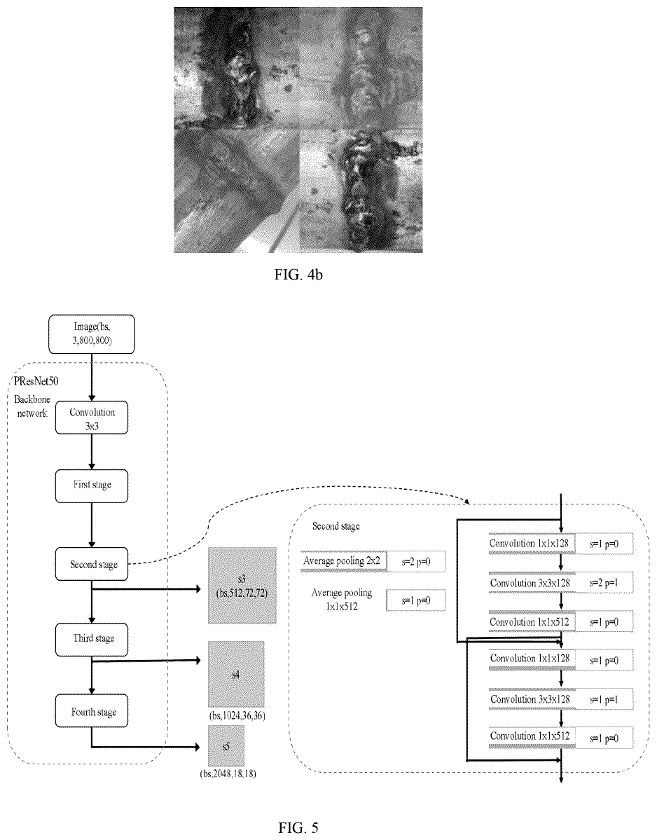

In addition, the S1 further includes: expanding the deposition defect dataset by using a data augmentation method. As shown in FIG. 4, The deposition defect detection, due to combining the pixel-level data augmentation method, can provide more comprehensive and effective training data and improve the performance and generalization ability of the model. The Mosaic data augmentation method is adopted to expand the dataset. Four images are randomly selected first, and then spliced together through random scaling, cropping and arrangement to form new images (FIG. 4a, FIG. 4b). The deposition defects of the four images may appear at different positions in the new image, so the training model needs to learn to detect objects at different positions and scales, making it more adaptable and robust.

S2. constructing a high-efficiency hybrid encoder by combining an attention mechanism and multi-layer convolution operation, capturing high-level semantic features in the key deposition features and performing multi-scale feature fusion through the high-efficiency hybrid encoder.

In S2, the high-efficiency hybrid encoder is used to improve the capture and fusion of deposition features. Specifically, the high-efficiency hybrid encoder includes an Intra-scale Feature Interaction (AIFI) module based on an attention mechanism and a Cross-scale Feature Fusion Module (CCFM) based on a Convolutional Neural Network (CNN). The Intra-scale Feature Interaction module is used to capture high-level semantic features in the deposition features to distinguish various types of deposition defects and reduce computational redundancy. The Cross-scale Feature Fusion Module uses convolution blocks to fuse multi-scale features, enhance the overall deposition feature information, and improve the accuracy and efficiency of the detection model.

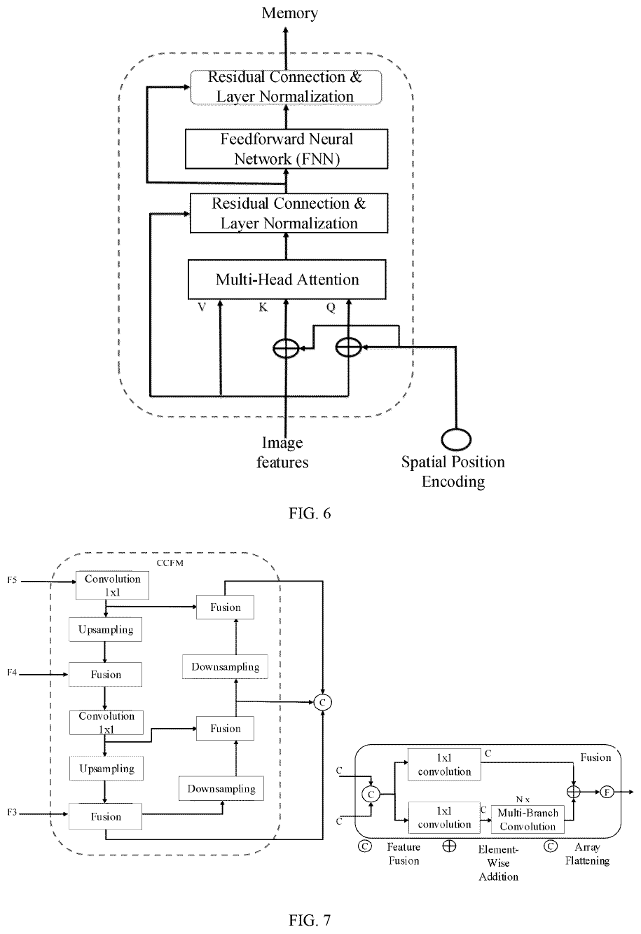

As shown in FIG. 6 and FIG. 7, in step S2, the deposition features S3, S4 and S5 are derived from the 2nd, 3rd and 4th stages of the backbone network in step S1 respectively. Compared with the shallower deposition features S3 and S4, the deeper deposition feature S5 contains higher-level and richer deposition semantic features, which is crucial for the Transformer decoder to distinguish different deposition features. Since the shallow features in the deposition features have relatively few semantics, Intra-scale Feature Interaction is performed on the deposition feature S5 (FIG. 6), and convolution layers are used to process the deposition features S3 and S4 to extract deposition features. The deposition features are subjected to cross-scale fusion through the feature maps output by the encoder (FIG. 7) to realize multi-scale deposition feature collection and significantly reduce the computational cost at the same time.

Multiple convolution fusion blocks are inserted into the feature fusion path to merge adjacent feature maps into a new feature map. The network module adopts a parallel structure to extract deposition features of different degrees from these deposition feature maps, and performs addition and dimension transformation on these deposition feature maps. The deposition feature maps of three different scales are combined to enhance the effect of deposition feature fusion.

S3. adopting an Intersection over Union (IoU) aware query selection method to assign corresponding classification scores to key deposition features with different IoU values during a training process to constrain model learning, and selecting more accurate key deposition features in a decoding stage by optimizing object queries.

S4. mapping optimized objects to classification confidence and bounding boxes by using a decoder with an auxiliary prediction head, and accelerating training convergence through a denoising module in the decoder.

### Example 2

On the basis of Example 1, Example 2 of the present application provides a more specific real-time defect detection method for metal deposition based on artificial intelligence, including:

S1. acquiring a deposition defect dataset, and extracting key deposition features by using a backbone network.

S2. constructing a high-efficiency hybrid encoder by combining an attention mechanism and multi-layer convolution operation, capturing high-level semantic features in the key deposition features and performing multi-scale feature fusion through the high-efficiency hybrid encoder.

S3. adopting an Intersection over Union (IoU) aware query selection method to assign corresponding classification scores to key deposition features with different IoU values during a training process to constrain model learning, and selecting more accurate key deposition features in a decoding stage by optimizing object queries.

In S3, the IoU aware query selection is used to improve the accuracy of the prediction framework. Specifically, high and low classification scores are assigned to deposition features with high and low IoU values respectively to constrain model learning and improve the accuracy of the prediction framework, and effectively solve the problem of inconsistency between classification scores and IoU scores, and prevent the impact of prediction frameworks with high classification scores but inaccurate positions on detection results. By optimizing object queries, more accurate deposition features are selected in the decoding stage, and finally the accuracy and robustness of deposition defect detection are improved.

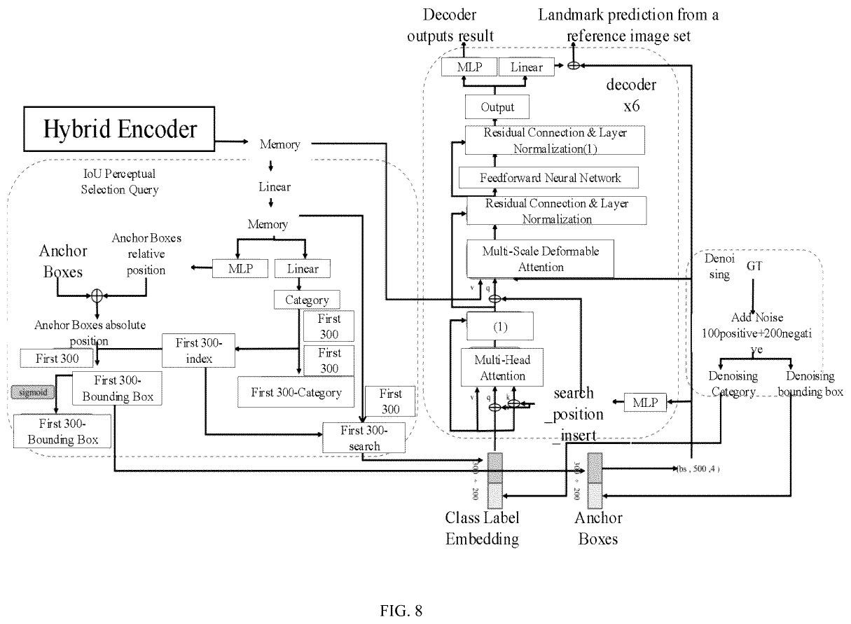

As shown in FIG. 8, in S3, the IoU aware query selection method is used to constrain the model during the training process to ensure the consistency between classification and IoU scores. Based on this, the object queries contain more encoder features, which are accurately classified and precisely located, thereby improving the accuracy of the detector.

In addition, Precision (P), Recall (R) and mean Average Precision (mAP) are adopted as evaluation indicators, and the IoU between the predicted and actual labeled boxes is adopted as the evaluation threshold. The IoU thresholds are divided into intervals from 0.50 to 0.95 with a step size of 0.05, that is, the Average Precision (AP) of 0.50:0.95 is calculated by sampling every 0.05 within this range, and finally the AP is the average of these individual precision calculations. AP50 represents the AP measurement value when the IoU threshold is 0.5. In the target detection model, mAP measures the average maximum precision of each category under different Recalls (R), balances precision and recall, and provides a single numerical performance indicator. The calculation formulas of P, R, mAP and AP are as follows:

$$P = \frac{TP}{TP + FP} \qquad ( 1 )$$

$$R = \frac{TP}{TP + FN} \qquad ( 2 )$$

$$AP = {\sum }_{k = 1}^{N} {max}_{\tilde{k} \geq k} p ( \tilde{k} ) Δ R ( k ) \qquad ( 3 )$$

$$mAP = \frac{{\sum }_{i = 1}^{N} {AP}_{i}}{n} \qquad ( 4 )$$

where a True Positive (TP), a False Positive (FP) and a False Negative (FN) respectively represent “true positive value”, “false positive value” and “false negative value”, which are defined according to an IoU between predicted bounding boxes and a ground truth. \tilde{k} is the Recall at any point on a Precision-Recall curve p(\tilde{k}); k is a serial number of interpolation points; N is a total number of interpolation points; p(\tilde{k}) is a Precision function at the Recall of \tilde{k}; ΔR(k) is a Recall variation between a (k−1)-th and k-th interpolation points; n is a total number of categories in multi-category object detection; i is a category serial number; the bounding box is labeled as the TP when the IoU is greater than the threshold for representing a number of correctly identified objects; the bounding box is labeled as the FP when the IoU is less than or equal to the threshold for representing a number of incorrectly identified objects;

In addition, in the research on detection speed, Frames Per Second (FPS) is used as the main indicator for evaluating detection speed, which represents the number of image frames that the model can process per second. The higher the FPS, the faster the model processing speed and the higher the real-time performance.

S4. mapping optimized objects to classification confidence and bounding boxes by using a decoder with an auxiliary prediction head, and accelerating training convergence through a denoising module in the decoder.

In S4, the decoder with an auxiliary prediction head is used to improve the classification and bounding box prediction accuracy. Specifically, after the object queries are optimized by the Transformer decoder, the auxiliary prediction head maps the optimized objects to classification confidence and bounding boxes to accurately detect deposition defect features. The denoising module in the decoder accelerates training convergence, enabling the training model to learn the position and classification of deposition defects more quickly and accurately.

As shown in FIG. 8, in step S4, during the training process, the ground truth boxes are denoised and used as a part of input of the decoder, which enables the queries of the decoder to predict specific targets more accurately and accelerates the convergence speed of the training process.

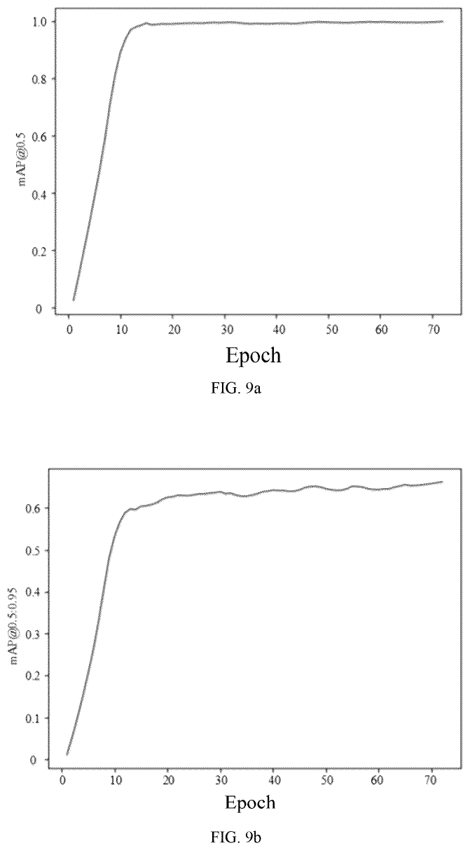

As shown in FIG. 9, the setting of hyperparameters for network training is also crucial. If the learning rate is too high, the model may eventually oscillate around the optimal solution. If it is too low, more training stages may be required, leading to inefficient use of resources. To solve this problem, a piecewise decay schedule and linear warm-up are adopted to set the learning rate. In this example, the base learning rate is set to 0.0001, and the piecewise decay coefficient is 0.9, that is, the learning rate is multiplied by 0.9 for every 100 training times. The linear warm-up learning rate starts from 0.00001 and gradually increases to the base learning rate of 0.001 in the first 2000 steps. The used optimizer is Adam W3d with a weight decay of 0.05 to prevent overfitting caused by large penalty weight values. During the training process, gradient clipping is adopted to limit the gradient value and avoid gradient explosion. The maximum gradient norm is set to 0.1. The evolution process of mAP@0.5 (mean Average Precision within the IoU threshold of 0.5) (FIG. 9a) and the evolution process of mAP@0.5:0.95 (mean Average Precision within the IoU threshold of 0.5~0.95) obtained during the training process of the real-time detection method (RT-DETR) of the present application are shown in the figures.

In addition, the examples of the present application also provide the real-time detection of deposition defects by the above method in the application scenario of wire arc additive manufacturing (WAAM).

In the metal wire arc additive manufacturing process, the quality and geometric shape of the deposited part are crucial to the strength and overall quality of the formed structural parts. However, manual inspection in a high-temperature environment will bring serious potential safety hazards and is prone to subjective errors. The real-time deposition defect detection method proposed by the present application aims to realize end-to-end automatic real-time detection of deposition defects in the wire arc additive manufacturing process, and significantly improve the detection accuracy and timeliness.

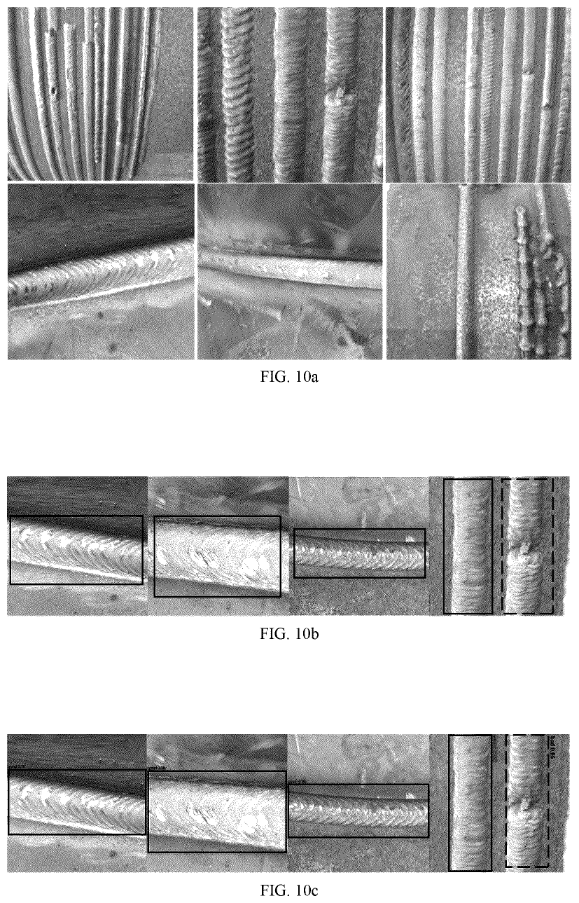

As shown in FIG. 10, a wire arc additive manufacturing system is used for the deposition process of metal wire, which includes a flexible six-axis robot and a stable fuse power supply. 316L stainless steel wire is used for deposition to obtain original deposition images.

As shown in FIG. 10, the original deposition image of the wire arc additive manufacturing process (FIG. 10a) is cropped into an image with a resolution of 800×800 pixels and labeled according to the requirements in step S1 to obtain a labeled deposition image of the wire arc additive manufacturing process (FIG. 10b). It can be seen that there are significant differences in the deposition quality of the wire arc additive manufacturing process, indicating that various defects and inconsistencies may occur during the deposition process. This emphasizes the importance of real-time deposition defect detection, which can realize timely identification and correction to ensure that the deposition quality meets the standards. The real-time detection also reduces rework and material waste, and improves production efficiency and safety.

The detection details of the real-time detection result image of deposition defects in the wire arc additive manufacturing process (FIG. 10c) are shown in Table 1. It can be seen that the mAP@0.5:0.95 (mean Average Precision within the IoU threshold of 0.5~0.95) of the real-time detection method (RT-DETR) of the present application is 0.801, which has the highest accuracy compared with other models. The FPS (Frames Per Second) of the real-time detection method of the present application is 67, which is superior to other models, reflecting its advantages in accuracy and timeliness.

TABLE 1
Comparison of detection performance of different models.

| Model | mAP@0.5 | mAP@0.5:0.95 | FPS |
|---|---|---|---|
| Faster Rcnn | 0.971 | 0.712 | 16 |
| SSD | 0.976 | 0.656 | 28 |
| Yolov5s | 0.985 | 0.731 | 48 |
| DETR | 0.982 | 0.722 | 26 |
| RT-DETR | 0.992 | 0.801 | 67 |

It should be noted that the parts in this example that are the same as or similar to those in Example 1 can be referred to each other, and will not be repeated in the present application.

### Example 3

On the basis of Example 1 and Example 2, Example 3 of the present application provides a real-time defect detection system for metal deposition based on artificial intelligence, including:
an acquisition module, configured to acquire a deposition defect dataset, and extracting key deposition features by using a backbone network;
a construction module, configured to construct a high-efficiency hybrid encoder by combining an attention mechanism and multi-layer convolution operation, capturing high-level semantic features in the key deposition features and performing multi-scale feature fusion through the high-efficiency hybrid encoder;
an assignment module, configured to adopt an Intersection over Union (IoU) aware query selection method to assign corresponding classification scores to key deposition features with different IoU values during a training process to constrain model learning, and select more accurate key deposition features in a decoding stage by optimizing object queries; and
a mapping module, configured to map optimized objects to classification confidence and bounding boxes by using a decoder with an auxiliary prediction head, and accelerate training convergence through a denoising module in the decoder.

It should be noted that the system provided in this example corresponds to the methods provided in Example 1 and Example 2, therefore, the parts in this example that are the same as or similar to those in Example 1 and Example 2 can be referred to each other, and will not be repeated in the present application.

In summary, the real-time defect detection method for metal deposition based on artificial intelligence provided by the present application extracts key deposition features through the backbone network to improve the detection accuracy of deposition defects, improves the capture and fusion of deposition features through the high-efficiency hybrid encoder to enhance the accuracy and efficiency of the detection model, improves the accuracy of the prediction framework through IoU aware query selection, and improves the classification and bounding box prediction accuracy through the decoder with an auxiliary prediction head. Taking deposition defects as the research object, it designs an artificial intelligence algorithm model of end-to-end Real-Time Detection Transformer (RT-DETR), which has fast training speed and strong generalization ability, and is suitable for application scenarios of metal wire deposition forming structural parts that require efficient, real-time and accurate detection such as wire arc additive manufacturing. Moreover, the method of the present application is proved to be effective through practical verification.

What is claimed is:

1. A real-time defect detection method for metal deposition based on artificial intelligence, comprising:
S1. acquiring a deposition defect dataset, and extracting key deposition features by using a backbone network;
S2. constructing a high-efficiency hybrid encoder by combining an attention mechanism and multi-layer convolution operation, capturing high-level semantic features in the key deposition features and performing multi-scale feature fusion through the high-efficiency hybrid encoder;
S3. adopting an Intersection over Union (IoU) aware query selection method to assign corresponding classification scores to key deposition features with different IoU values during a training process to constrain model learning, and selecting more accurate key deposition features in a decoding stage by optimizing object queries; and
S4. mapping optimized objects to classification confidence and bounding boxes by using a decoder with an auxiliary prediction head, and accelerating training convergence through a denoising module in the decoder.

2. The real-time defect detection method for metal deposition based on artificial intelligence according to claim 1, wherein step S1 further comprises:
expanding the deposition defect dataset by using a data augmentation method.

3. The real-time defect detection method for metal deposition based on artificial intelligence according to claim 2, wherein in step S1:
for the deposition defect dataset, labeling samples as “good” or “bad” according to a presence or absence of defects and conduct annotation;
wherein deposition defects comprise deposition burrs, deposition holes and deposition dents;
dividing the deposition defect dataset into a training set and a validation set, which are configured for model training and performance evaluation respectively;
wherein the backbone network is a modified PResNet50, in which an initial 7×7 convolution layer is replaced with three 3×3 convolution layers, and a 2×2 average pooling layer is introduced into residual blocks to replace part of 1×1 convolution layers; and
the modified PResNet50 is configured to enhance a retention of key deposition information and improve an efficiency of deposition feature extraction.

4. The real-time defect detection method for metal deposition based on artificial intelligence according to claim 3, wherein in step S2: the high-efficiency hybrid encoder comprises an intra-scale feature interaction module based on an attention mechanism and a cross-scale feature fusion module based on a convolutional neural network;
the intra-scale feature interaction module is configured to capture high-level semantic features in the key deposition features;
the cross-scale feature fusion module is configured to fuse multi-scale features and enhance overall deposition feature information;
for shallow deposition features, convolution layers are adopted for extraction;
for deep deposition features containing corresponding high-level deposition semantic features, deposition feature maps output by the high-efficiency hybrid encoder are used for cross-scale fusion to perform multi-scale deposition feature extraction and improve the efficiency of deposition feature extraction; and
a parallel structure is adopted to extract deposition features of different degrees from the deposition feature maps, and deposition feature maps of various scales are combined to enhance the fusion effect of the key deposition features.

5. The real-time defect detection method for metal deposition based on artificial intelligence according to claim 4, wherein in step S3: a Precision, a Recall and a mean Average Precision (mAP) are adopted as evaluation indicators, and an IoU between predicted labeled boxes and actual labeled boxes is adopted as an evaluation threshold;
calculation formulas of the Precision, the Recall, an Average Precision (AP) and the mAP are as follows:
$$P = \frac{TP}{TP + FP} \qquad ( 1 )$$
$$R = \frac{TP}{TP + FN} \qquad ( 2 )$$
$$AP = {\sum }_{k = 1}^{N} {max}_{\tilde{k} \geq k} p ( \tilde{k} ) Δ R ( k ) \qquad ( 3 )$$
$$mAP = \frac{{\sum }_{i = 1}^{N} {AP}_{i}}{n} \qquad ( 4 )$$
wherein, P represents the Precision, R represents the Recall, AP represents the Average Precision, mAP represents the mean Average Precision; a True Positive (TP), a False Positive (FP) and a False Negative (FN) respectively represent “true positive value”, “false positive value” and “false negative value”, which are defined according to an IoU between predicted bounding boxes and a ground truth; \tilde{k} is the Recall at any point on a Precision-Recall curve p(\tilde{k}); k is a serial number of interpolation points; N is a total number of interpolation points; p(\tilde{k}) is a Precision function at the Recall of \tilde{k}, ΔR(k) is a Recall variation between a (k−1)-th and k-th interpolation points; n is a total number of categories in multi-category object detection; i is a category serial number; the bounding box is labeled as the TP when the IoU is greater than the threshold for representing a number of correctly identified objects; the bounding box is labeled as the FP when the IoU is less than or equal to the threshold for representing a number of incorrectly identified objects;
Frames Per Second (FPS) is adopted as a main indicator for evaluating detection speed when measuring the detection speed.

6. The real-time defect detection method for metal deposition based on artificial intelligence according to claim 5, wherein in step S4: during the training process, the ground truth boxes are denoised and used as a part of an input of the decoder to accelerate a training convergence speed; a piecewise decay schedule and linear warm-up are adopted to set a learning rate for solving a problem of training hyperparameters.

7. A real-time defect detection system for metal deposition based on artificial intelligence, for executing the method according to claim 1, and comprising:
an acquisition module, configured to acquire a deposition defect dataset, and extracting key deposition features by using a backbone network;
a construction module, configured to construct a high-efficiency hybrid encoder by combining an attention mechanism and multi-layer convolution operation, capturing high-level semantic features in the key deposition features and performing multi-scale feature fusion through the high-efficiency hybrid encoder;
an assignment module, configured to adopt an Intersection over Union (IoU) aware query selection method to assign corresponding classification scores to key deposition features with different IoU values during a training process to constrain model learning, and select more accurate key deposition features in a decoding stage by optimizing object queries; and
a mapping module, configured to map optimized objects to classification confidence and bounding boxes by using a decoder with an auxiliary prediction head, and accelerate training convergence through a denoising module in the decoder.

8. A computer storage medium, wherein a computer program is stored in the computer storage medium; when the computer program runs on a computer, the computer is configured to execute the method according to claim 1.

9. An electronic device, comprising: a memory, configured to store a computer program; a processor, configured to execute the computer program to implement the method according to claim 1.
